(19) United States
(12) Patent Application Publication
(10) Pub. No.: US 2018/0257485 A1
(43) Pub. Date: Sep. 13, 2018

(54) POWERTRAIN FOR A MOTOR VEHICLE

(71) Applicant: DAIMLER AG, Stuttgart (DE)

(72) Inventor: Florian Vincon, Stuttgart (DE)

(21) Appl. No.: 15/912,671

(22) Filed: Mar. 6, 2018

(30) Foreign Application Priority Data
Mar. 7, 2017 (DE) 10 2017 002 198.8

(51) Int. Cl. B60K 17/24; B60K 17/12; B60K 1/04

(52) U.S. Cl. CPC B60K 17/24; B60K 8/00; B60K 1/04; B60K 17/12

(57) ABSTRACT

A powertrain for a motor vehicle includes at least one electrical machine having a stator and a rotor that is rotatable relative to the stator and at least one driveshaft, via which at least one wheel of the motor vehicle can be driven by the electrical machine. At least one longitudinal region of the driveshaft, which has at least one joint, is arranged in the rotor and surrounded by the rotor at least in the circumferential direction of the driveshaft.

### BACKGROUND AND SUMMARY OF THE INVENTION

Exemplary embodiments of the invention relate to a powertrain for a motor vehicle, specifically for a commercial vehicle.

German patent document DE 10 2005 025 357 A1 discloses a powertrain that includes at least one electrical machine having a stator and a rotor that rotates around a rotational axis relative to the stator. In addition, at least one driveshaft is provided, by means of which at least one wheel of the motor vehicle can be driven by the electrical machine. More specifically, for example, several wheels of the motor vehicle can be driven by the electrical machine via the driveshaft, thus allowing for the overall motor vehicle to be driven by the electrical machine, or the electrical machine can at least support the propulsion of the motor vehicle.

Exemplary embodiments of the invention are directed to a powertrain that minimizes the required installation space for the powertrain.

According to an aspect of the invention, axial installation space requirements of the powertrain can be minimized by providing at least one longitudinal region having at least one joint of the driveshaft located in the rotor and surrounded by the rotor, at least in the circumferential direction of the driveshaft. In other words, according to embodiments, to dimension the rotor of the electric machine appropriately large in terms of its diameter and, specifically, large enough so that at least one part or parts of the driveshaft, which is to say at least the longitudinal region of the driveshaft, is located in the rotor and is enclosed by the rotor, at least in the circumferential direction. This can minimize the overall length of the powertrain particularly, specifically in the axial direction of the electrical machine or the powertrain, which can, for example, allow for the creation of additional installation space for components such as batteries and/or other ancillary equipment of the motor vehicle, which is, for example, designed as a commercial vehicle.

Aspects of the invention are specifically based on the knowledge that, especially when an axle, such as a rigid axle of a motor vehicle, and more specifically, wheels of, for example, an axle designed for example as a rigid axle of a motor vehicle, is to be powered by at least one driveshaft of an electrical machine, then the driveshaft must be dimensioned such that the axle and its wheels remain driveable in all driving situations. For this reason, it is not possible to make the driveshaft arbitrarily short. In the normal case, the installation space in the region of the driveshaft can scarcely or cannot be used for batteries, so that the driveshaft has been identified as a decisive influencing factor for a potentially installable battery capacity. Since it is envisaged according to the invention to arrange at least the longitudinal region, and hence the joint arranged in the longitudinal region, in the rotor, additional installation space can be created so that batteries and/or other ancillary equipment or components can be arranged in the region of the driveshaft. In this regard, the stator can run only partially coaxially in relation to the driveshaft so as to keep the installation space requirement particularly low.

Additional advantages, characteristics and details of the invention are found in the following description of a preferred exemplary embodiment, as well as on the basis of the drawing. The features and combinations of features mentioned above in the description, in addition to the features and combinations of features presented in the descriptions of the figures and/or solely in the figures themselves, are not only usable in each presented combination, rather they can also be used in other combinations or alone, without departing from the scope of the invention.

### BRIEF DESCRIPTION OF THE DRAWING FIGURES

FIG. 1 shows a schematic perspective view of a powertrain for a motor vehicle, where at least one longitudinal region of a driveshaft that has at least one joint is arranged in a rotor of an electrical machine, and is surrounded by the rotor, at least in the circumferential direction of the driveshaft, and

FIG. 2 a schematic and partially split cutaway view of the powertrain.

Elements in the figures that are identical or that perform identical functions are assigned identical signs.

### DETAILED DESCRIPTION

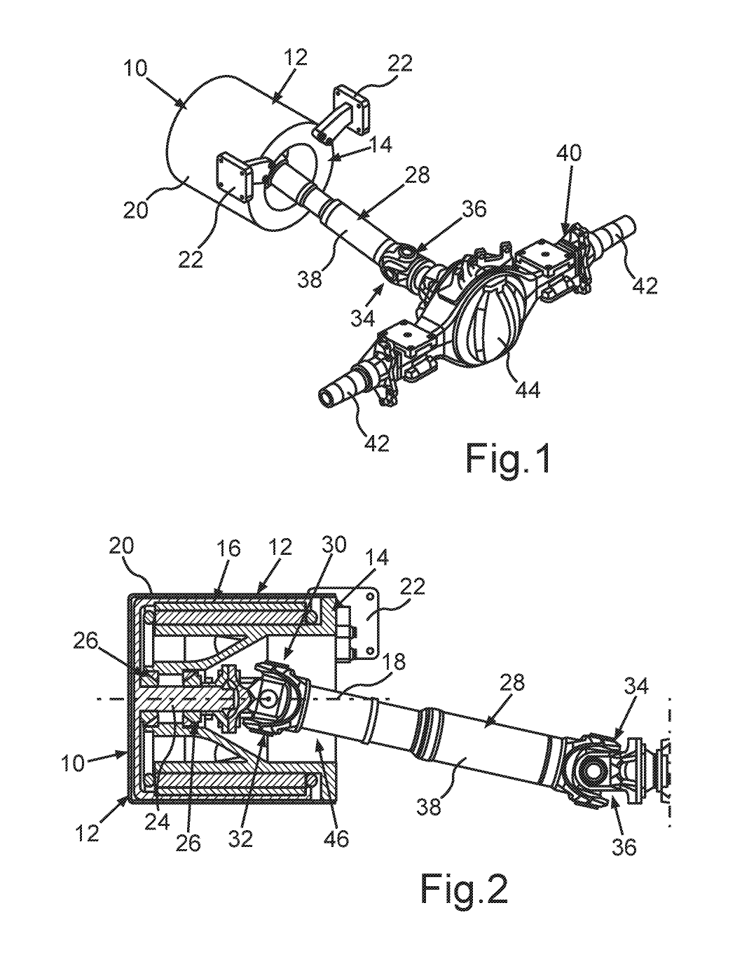

FIG. 1 is a schematic perspective view of a powertrain in its entirety, marked “10”, for a motor vehicle, specifically a commercial vehicle. As can be seen particularly well when viewed in conjunction with FIG. 2, the powertrain 10 comprises at least one electrical machine 12 which comprises a stator 14 and a rotor 16. The rotor 16 is rotatable around a rotational axis 18 relative to the stator 14. As can be seen in FIG. 2, the electrical machine 12 is designed as an external rotor machine. This means that the rotor 16 is designed as an external rotor and is therefore located at least partially, in the radial direction, outside the stator 14 and at least partially surrounds and encloses the outer circumference of the stator 14. The design of the electrical machine 12 as an internal rotor machine is also conceivable, such that the rotor 16 would then be designed as an internal rotor.

At the same time, the electrical machine 12 has a housing 20, which is connected, for example, to the stator 14, and at least partially, particularly at least predominantly or completely encloses the stator 14 and the rotor 16. FIG. 1 demonstrates particularly well that the stator 14 is connected to retaining brackets 22 via which the stator 14 is fastened to a frame of the commercial vehicle (not shown in this figure). Thus, the rotor 16 is for example rotatably held on the frame via the stator 14 and the retaining brackets 22.

FIG. 2 demonstrates particularly well that the rotor 16, which can be driven by the stator 14, has at least one rotor shaft 24, which is rotatable around the rotational axis 18 relative to the stator 14. At the same time, the rotor 16 is rotatably mounted to the stator 14 via the rotor shaft 24 and, by way of example, a bearing designed as an anti-friction bearing 26. The powertrain 10 also includes at least one driveshaft 28, which could be designed as, for example, as a cardan shaft. The driveshaft 28, specifically at its first end 30, includes a first joint 32 and, specifically at its second end 34, which is opposite first end 30, a second joint 36.

In the exemplary embodiment illustrated in FIG. 2, the respective joint 32 or 36 is designed as a universal joint. As an alternative, the design of the joint 32 and the joint 36 as constant-velocity joints is also possible. In the axial direction of the driveshaft 28, a corrugated tube 38 is located between the joints 32 and 36, which connects the joints 32 and 36. At the same time, the driveshaft 28 is articulated using the joint 32 and non-rotatably connected to the rotor shaft 24 and thus to the overall rotor 16, so that the driveshaft 28 can be driven by the rotor 16 and, consequently, the electrical machine 12, via the joint 32 and the rotor shaft 24.

In addition, the powertrain 10 includes an axle, designed as rigid axle 40 in the exemplary embodiment and illustrated in the figure, which—particularly in the vehicle's fully manufactured state—has at least two wheels spaced from each other in the transverse direction of the vehicle (not illustrated in the figure). The rigid axle 40 has respective axle spindles 42 that are spaced from each other in the transverse direction of the vehicle, and to which the wheels can be non-rotatably connected. At the same time, the axle spindles 42 can be driven by the driveshaft 28, and can thus be driven thereby via the rotor 16 and the electrical machine 12 as a whole, so that the wheels (not illustrated in the figure) of the rigid axle 40 can be driven by the electrical machine 12, and more specifically, by the rotor 16, via the axle spindles 42 and the driveshaft 28. As a result, the motor vehicle as a whole can be driven using the electrical machine 12, so that the motor vehicle can be designed, for example, as a hybrid or electric vehicle. The electrical machine 12 can be operated in a motor mode and thus as an electric motor. In the motor mode, the rotor 16 is driven by the stator 14, with the result that the wheels are driven by the electrical machine 12 via the driveshaft 28.

The rigid axle 40 also has a differential housing 44 in which an axle drive (not visible in the figure) is located. The axle drive is also termed a differential or differential transmission, wherein the axle spindles 42 and the wheels can be driven by the driveshaft 28 via the axle drive. The function of this type of differential transmission is sufficiently well-known, in that the differential transmission, specifically when the vehicle is cornering, allows for speed compensation between the drivable/driven wheels, since the wheel in the outside of the curve can rotate at a higher speed than the wheel in the inside of the curve. The axle drive can be designed, for example, as a bevel gear differential. Overall it is recognizable that the rigid axle 40 can be driven by the driveshaft 28, and thereby by the electrical machine 12, and more specifically the rotor 16. At the same time, the driveshaft 28 is, for example, non-rotatably connected via the joint 36 to a pinion that is particularly located in the differential housing 44, not visible in the figure, and engages for example with a crown gear of the axle drive located in the differential housing 44. As a result, the axle drive can be driven by the pinion, and consequently the driveshaft 28, via the crown gear. At the same time, the joint 32 must at least be substantially connected to the rotor shaft 24 and the rotor 16 directly, with the result that the electrical machine 12, particularly when in its motor mode, can drive the driveshaft 28 directly.

In order to minimize the axial length and thus the installation space requirement of powertrain 10, at least one longitudinal region 46 that includes joint 32 of driveshaft 28 is located in rotor 16 and surrounded or enclosed by rotor 16 in at least the circumferential direction of driveshaft 28 or rotor 16 or stator 14. At the same time, it is recognizable from FIG. 2 that longitudinal region 46, which is arranged in rotor 16 and surrounded and enclosed by rotor 16, also comprises part of corrugated tube 38.

Furthermore, because the electrical machine 12 is designed as an external rotor machine, the longitudinal region 46 is also arranged in the stator 14 and the driveshaft 28 is surrounded and enclosed by the stator 14 at least in the circumferential direction. As a result, the rotor 16 and the stator 14 are dimensioned with regard to their respective diameters such that the longitudinal region 46 is enclosed by the rotor 16 and the stator 14. At the same time, the stator 14 runs, for example, only partially coaxially to the driveshaft 28. As a result of this at least partial arrangement of the driveshaft 28 in the rotor 16, it is possible, for example, for the rigid axle 40 to be located close to the electrical machine 12 in the axial direction of the electrical machine 12 or the overall powertrain 10, so that the installation space requirement can be kept minimal, particularly in the axial direction. In this way, for example, additional installation space can be created for at least one battery and/or another component of the motor vehicle.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### REFERENCE SIGN LIST

### 10 Powertrain

12 Electrical machine

### 14 Stator

### 16 Rotor

18 Rotational axis

### 20 Housing

22 Retaining bracket
24 Rotor shaft

### 26 Bearing

### 28 Driveshaft

### 30 First end

### 32 Joint

### 24 Second end

### 36 Joint

38 Corrugated tube
40 Rigid axle
42 Axle spindle
44 Differential housing
46 Longitudinal region

What is claimed is:

1. A powertrain for a motor vehicle, the powertrain comprising:
at least one electrical machine having a stator and a rotor that is rotatable relative to the stator; and
at least one driveshaft, via which at least one wheel of the motor vehicle is driveable by the electrical machine,
wherein at least one longitudinal region of the driveshaft, which has at least one joint, is arranged in the rotor and surrounded by the rotor at least in a circumferential direction of the driveshaft.

2. The powertrain of claim 1, wherein the at least one electrical machine has an external rotor at least partially surrounding the stator.

3. The powertrain of claim 1, wherein the joint is a universal joint.

4. The powertrain of claim 1, wherein the joint is constant velocity joint.

5. The powertrain of claim 1, further comprising:
a rigid axle coupled to the driveshaft so that the rigid axle is driveable by the at least one electric machine.
